(19) United States
(12) Patent Application Publication
(10) Pub. No.: US 2022/0375374 A1
(43) Pub. Date: Nov. 24, 2022

(54) SYSTEMS, DEVICES, AND METHODS FOR DIRECTING AND MANAGING IMAGE DATA FROM A CAMERA IN WEARABLE DEVICES

(71) Applicant: GOOGLE LLC, Mountain View, CA (US)

(72) Inventors: Stuart James Myron Nicholson, Waterloo (CA); Nils Johan Fransson, Waterloo (CA); Cecilia Ka Vai Mok, Kitchener (CA); David James Mak-Fan, Waterloo (CA)

(21) Appl. No.: 17/771,760

(22) PCT Filed: Feb. 3, 2021
(86) PCT No.: PCT/US2021/016319

§ 371 Date: Apr. 25, 2022

Related U.S. Application Data
(60) Provisional application No. 62/969,699, filed on Feb. 4, 2020.

(51) Int. Cl. G09G 3/00; G02B 27/01; H04N 5/232; H04N 7/18; G06T 11/00; G06V 20/10

(52) U.S. Cl. CPC G09G 3/002; G02B 27/0172; H04N 5/23245; H04N 7/183; G06T 11/001; G06V 20/10; G02B 2027/0178; G02B 2027/014; G02B 2027/0138; G02B 2027/0112; H04N 19/00

(57) ABSTRACT

A controller bypasses processing raw image data captured by an image sensor at a wearable device and selects among modes of operation, to direct the raw image data to a light engine, to a transmitter, and/or to a computer vision engine. The light engine outputs display light based on the raw image data, the transmitter transmits the raw image data external to the wearable device, and the computer vision engine analyzes the raw image data to identify at least one feature represented in the raw image data and outputs computer vision data. The modes of operation selected by the controller reduce or eliminate intensive image signal processing operations performed by the wearable device on the raw image data.

### TECHNICAL FIELD

The present systems, devices, and methods generally relate to wearable devices which include at least one camera and particularly relate to directing and managing image data sensed by said at least one camera.

### BACKGROUND

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on. Because they are worn on the body of the user, and typically visible to others, and generally present for long periods of time, form factor (i.e., size, geometry, and appearance) is a major design consideration in wearable electronic devices.

Head-mounted wearable devices are devices to be worn on a user's head when in use. Wearable head-mounted devices include head-mounted displays and can also include head-mounted devices which do not include displays. A head-mounted display is an electronic device that, when worn on a user's head, secures at least one electronic display within a viewable field of at least one of the user's eyes. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. A head-mounted device which does not include a display can include other components, such as a camera, microphone, and/or speakers.

Some wearable devices include at least one camera, which can be used for applications like capturing photographs, as well as for applications like computer vision, where at least one image sensed by a camera is analyzed by at least one processor. Head-mounted wearable devices in particular benefit from the inclusion of at least one camera, since these devices are worn on a user's head and the at least one camera can be positioned and oriented to sense image data which approximates a user's field of view. However, other wearable devices, such as smartwatches, also include at least one camera.

### SUMMARY

The present disclosure relates to a wearable heads-up display (“WHUD”) comprising: an image sensor to sense and output raw image data; a transmitter (which may be part of a communication module) to transmit data external to the WHUD; and a controller communicatively coupled to the image sensor and the transmitter, wherein the controller is configured to direct the raw image data from the image sensor to the transmitter for transmission to an image signal processor external to the WHUD. The external image signal processor may be a component of a peripheral device such as a smartphone, PDA, digital assistant, tablet, or of a server. The controller may be any suitable component which can execute instructions or logic, and/or direct signals, including, for example, a micro-controller, microprocessor, multi-core processor, integrated-circuit, ASIC, FPGA, programmable logic device, or any appropriate combination of these components.

The WHUD may further comprise a light engine or a light engine assembly to output display light; an optical combiner to receive the display light and redirect the display light to form a display visible to a user of the WHUD; wherein the controller may further be configured to operate in a first mode and a second mode, wherein: when the controller is operated in the first mode, the controller may direct the raw image data from the image sensor to the transmitter, and the transmitter may be to transmit the raw image data external to the WHUD; and when the controller is operated in the second mode, the controller may be configured to direct the raw image data from the image sensor to the light engine, and the light engine may be to output the display light based on the image data.

The raw image data may comprise a Bayer pattern image.

Further, the WHUD may comprise an image data conditioner to condition the raw image data wherein: the image data from the image sensor may include a plurality of color channels, wherein each color channel represents a color different from the colors of the other channels; the light engine may include at least a plurality of light sources, each light source driven according to a corresponding one of the plurality of color channels to output display light having a wavelength in a waveband different from the wavebands of the other light sources; and wherein the conditioner may be configured to adjust a color channel of the plurality of color channels and may provide the conditioned image to the light engine when the controller is operated in the second mode. “Conditioning” the image data may refer to performing some mild or moderate optimization of image data to be compatible with the light, engine, without e.g. being as intensive as full ISP processing.

The conditioner may be configured to adjust the color channel by summing or averaging the values of two of the color channels and may provide the conditioned image data to the light engine when the controller is operated in the second mode.

The WHUD may further comprise a computer vision engine, the controller further may be selectively operable in a third mode, wherein when the controller is operated in the third mode, the controller is to direct the image data from the image sensor to the computer vision engine, the computer vision engine may be configured to analyze the image data to detect at least one feature represented in the image data and optionally may be to output computer vision data which identifies or includes a representation of, the at least one detected feature represented in the image data.

The WHUD may further comprise a synthesizer, wherein when the controller is operated in the second mode, the controller may be configured to direct the image data from the image sensor to the synthesizer, the synthesizer may be configured to synthesize the image data with virtual content and may provide synthesized image data including the virtual content to the light engine, the light, engine may be to output the display light based on the synthesized image data.

Further, the WHUD may comprise a compressor, wherein when the controller is operated in the first mode, the controller is to direct the image data from the image sensor to the compressor, the compressor to compress the image data and may provide compressed image data to the transmitter, wherein the transmitter may transmit the compressed image data external to the WHUD.

The present disclosure also relates to a method, comprising: sensing, by an image sensor of a wearable heads-up display (WHUD), in particular as described above, raw image data; directing, by a controller of the WHUD, the raw image data from the image sensor to a transmitter for transmission of the raw image data external to the WHUD.

The method may further comprise selecting, by the controller of the WHUD, to operate in at least one of a first mode and a second mode, wherein, in the first mode, the controller may be to direct the raw image data from the image sensor to the transmitter for transmission of the raw image data external to the WHUD; and/or in the second mode, the controller may be to direct the raw image data from the image sensor to a light engine of the WHUD for output of display light based on the raw image data.

### BRIEF DESCRIPTION OF THE SEVERAL VIEWS OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a schematic diagram of a wearable heads up display (WHUD) including a controller to direct raw image data for transmission to an external image signal processor (ISP) in accordance with some embodiments.

FIG. 2 is a flow chart illustrating a method of selecting between directing raw image data to a transmitter and directing raw image data to a light engine for display in accordance with some embodiments.

FIG. 3 is a block diagram of a system for selecting between directing raw image data to a transmitter and directing raw image data to a light engine for display in accordance with some embodiments.

FIG. 4 is a perspective view of an exemplary scene in which at least one embodiment of the present disclosure can be utilized.

FIG. 5 is a view of a preview which can be presented to a user in accordance with some embodiments.

FIG. 6 is a block diagram of a system for selecting between modes of operation in accordance with some embodiments.

FIG. 7 is a schematic view of a portion of an exemplary image sensor in accordance with some embodiments.

FIG. 8 is a schematic view of an exemplary scanning laser projector based light engine in accordance with some embodiments.

FIG. 9 is a schematic diagram of an exemplary image data pipeline in accordance with at least one illustrated implementation.

FIG. 10 is a flow chart illustrating a method of selecting between transmitting raw image data externally, directing raw image data for display, and directing raw image data to a computer vision engine in accordance with some embodiments.

FIG. 11 is a block diagram of a system for selecting between modes of operation in accordance with some embodiments.

FIG. 12 is a perspective view of an exemplary scene in which at least one implementation of the present disclosure can be utilized.

### DETAILED DESCRIPTION

Wearable electronic devices typically include image sensors having a sensor array that filters each pixel to record only one of three colors. To obtain a full-color image, certain formatting and quality of sensed image data, cameras often include, are integrated with, or are paired with an image signal processor (“ISP”). An ISP performs functions like demosaicing (interpolating color values from a sensor array), autofocus, autoexposure, auto color balancing, noise reduction, filtering, shading, distortion, and other image processing functions. Integrating or coupling a camera with an ISP at the wearable electronic device provides fast ISP results, but increases the size and power used by the overall camera module. This is disadvantages for portable and wearable devices, where size and power are at a premium. Thus, it is desirable to provide means for performing ISP functionality on image data from a camera when desired, while also limiting space and power used on wearable devices.

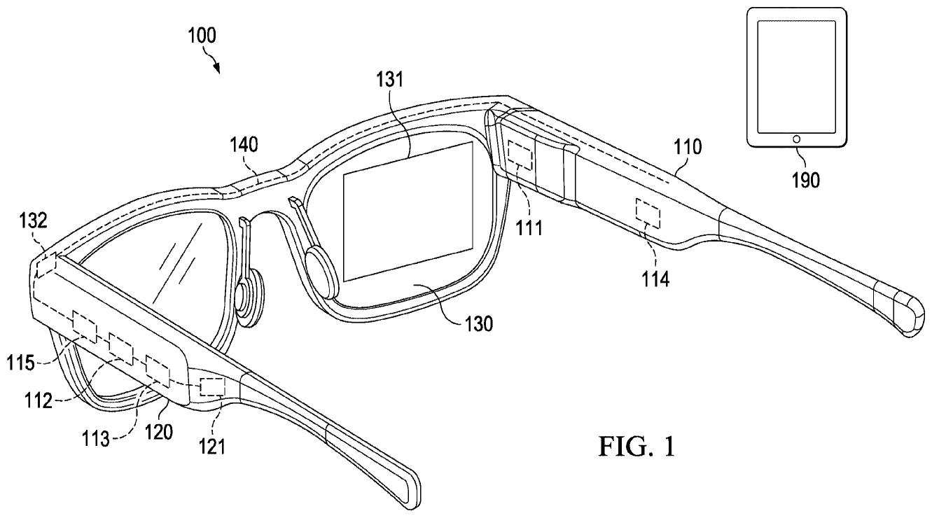

FIGS. 1-12 illustrate techniques for managing image data captured by a camera (also referred to herein as an image sensor) of a wearable device. To reduce the computational load of the wearable electronic device, as well as the amount of data generated and stored at, and transmitted from, the wearable electronic device, the wearable electronic device includes a controller that bypasses processing of raw image data at the wearable electronic device. Rather than processing the raw image data captured by the camera at the wearable electronic device, the controller directs the raw image data to a transmitter for transmission to an image signal processor (ISP) that is external to the wearable electronic device. In some embodiments, the controller selects among multiple modes of operation: to direct the raw image data from the image sensor to a light engine for display at the wearable electronic device, to direct the raw image data from the image sensor to the transmitter for transmission to an external ISP, and/or to direct the raw image data from the image sensor to a computer vision engine for analysis to identify at least one feature represented in the raw image data and output computer vision data. The different modes of operation can reduce or eliminate intensive ISP processing operations that would otherwise be performed by the wearable device, thereby conserving power and other resources.

FIG. 1 is a schematic diagram of a wearable heads up display (WHUD) including a controller to direct raw image data for transmission to an external image signal processor (ISP) in accordance with some embodiments. Wearable device 100 includes a first arm 110, a second arm 120, and a front frame 130 which is physically coupled to first arm 110 and second arm 120. When worn by a user, first arm 110 is to be positioned on a first side of a head of the user, second arm 120 is to be positioned on a second side of a head of a user opposite the first side of the head of the user, and front frame 130 is to be positioned on a front side of the head of a user.

In the illustrated example, first arm 110 carries a controller 112, non-transitory controller-readable storage medium 113, power supply circuit 114, and communication module 115. Second arm 120 carries power source 121. Front frame 130 carries at least one image sensor 132. FIG. 1 illustrates one image sensor 132, but one skilled in the art will appreciate that the exact number of image sensors, and the specific position of the image sensors, could be chosen as appropriate for a given wearable device design. For example, wearable device 100 could include only a single camera, or could include two, three, four, five, six, or more cameras. Further, although the at least one image sensor 132 is shown as being carried by front frame, at least one of image sensors 132 could be carried by first arm 110 or second arm 120.

The image sensor 132 detects raw image data from the environment of the wearable device 100. In some embodiments, each pixel of the image sensor 132 is filtered to record only one of three colors, such that the data from each, pixel does not fully specify value for each of the three colors. In such embodiments, the raw image data detected and output by the image sensor 132 is a Bayer pattern image. To obtain a full-color image from the raw image data, an ISP (not shown) applies a demosaicing algorithm to interpolate a set of complete color values for each pixel of the Bayer pattern image.

In some embodiments, the first arm 110 carries a light engine assembly (light engine) 111 which outputs light representative of display content to be viewed by a user. First arm 110 also carries additional components of wearable device 100, such as a processor, at least one non-transitory processor-readable storage medium, and a power supply circuit, for example. In some embodiments, front frame 130 carries an optical combiner 131 in a field of view of the user which receives light output from the light engine assembly 111 and redirects this light to form a display to be viewed by the user. In the case of FIG. 1, the display is a monocular display visible to a right eye of a user. Second arm 120 as shown in FIG. 1 carries a power source 121 which powers the components of wearable device 100. Front frame 130 may also carry a camera (e.g. comprising image sensor 132). Front frame 130 also carries at least one set of electrically conductive current paths 140 which provide electrical coupling between power source 121 and light engine 111, and any other electrical components carried by first arm 110. The at least one set of electrically conductive current paths 140 also provides electrical coupling between image sensor 132 and other components of wearable device 100, including power source 121 and/or at the processor carried by wearable device 100.

In some embodiments, the orientation of wearable device 100 is reversed, such that the display is presented to a left eye of a user instead of the right eye. In other embodiments, second arm 120 carries a light, engine assembly similar to light engine assembly 111 carried by first arm 110, and front frame 130 also carry an, optical combiner similar to optical combiner 131, such that wearable device 100 presents a binocular display to both a right eye and a left eye of a user. The wearable device 100 does not include a light engine or optical combiner at all in some embodiments, such that wearable device 100 is a wearable device which does not include a display.

Light engine assembly 111 and optical combiner 131 include display architecture for outputting light and redirecting, the light to form a display to be viewed by a user. Exemplary display architectures include, for example, scanning laser projector and holographic optical element combinations, side-illuminated optical waveguide displays, pin-light displays, or any other wearable heads-up display technology as appropriate for a given application. For example, in some embodiments, light engine 111, and any of the light engines discussed herein, include at least one of a projector, a scanning laser projector, a microdisplay, a white-light source, or any other display technology as appropriate for a given application.

Optical combiner 131 includes at least one optical component such as a waveguide, a holographic optical element, a prism, a diffraction grating, a light reflector, a light reflector array, a light refractor, a light refractor array, or any other light-redirection technology as appropriate for a given application, positioned and oriented to redirect the display light towards the eye of the user. Optical combiner 131 is carried by a lens which is carried by front frame 130. In various embodiments, the optical combiner 131 is a layer such as a molded or cast layer, a thin film, or a coating that, is formed as part of a lens, a layer adhered to a lens, a layer embedded within a lens, a layer, sandwiched between at least two lenses, or any other appropriate arrangement. As used herein, a “lens” refers to either a plano lens which applies no optical power and does not correct a user's vision, or a prescription lens which applies an optical power to incoming light to correct a user's vision.

To reduce processing demands at the wearable device 100, as well as the amount of data generated and stored at, and transmitted from, the wearable device 100, the wearable device 100 includes a controller 112 to direct the raw image data captured by the image sensor 132 to a communications module 115 comprising a transmitter (not shown) for transmission to an external image signal processor (ISP). The external ISP is a component of a peripheral device 190 such as a smartphone, PDA, digital assistant, tablet, or of a server (not shown). The wearable device 100 communicates with the peripheral device 190 or server via communications module 115 using long-range wireless communication hardware, such as hardware which enables 2G, 3G, 4G, 5G, LTE, or short-range wireless communication hardware, such, as hardware which enables Bluetooth®, ZigBee®, WiFi®, or other forms of wireless communication. In some cases, peripheral device 190 is a purpose-built processing pack designed to be paired with wearable device 100.

The controller 112 thus enables the wearable device 100 to off-load at least some processing burden from wearable device 100 to peripheral device 190. In this way, power consumption by wearable device 100 is reduced, thereby enabling, a smaller battery and/or longer battery life for wearable device 100 and a reduction in size or even elimination of one or more processors carried by wearable device 100.

In some embodiments, the image sensor 132 captures a relatively large amount of raw image data (e.g., 5 megapixels), whereas the light engine assembly 111 generates a display that includes a relatively small amount of image data (e.g., 0.5 megapixels). To conserve processing power, rather than processing the raw image data at an ISP prior to displaying an image based on the raw image data at the optical combiner 131, the controller 112 bypasses processing the raw image data at the wearable device 100 and instead directs the raw image data from the image sensor 132 to the light engine assembly 111 for display to the user, without first demosaicing or otherwise processing the raw image data at an ISP.

In other embodiments, the controller 112 directs the raw image data to a machine vision engine (not shown).

The controller 112 is communicatively coupled to each of the electrical components in wearable device 200, including but not limited to non-transitory controller readable storage medium 113, power supply circuit 114, and communications module 115. The controller 112 is any suitable component which can execute instructions or logic, and/or direct signals, including but not limited to a micro-controller, microprocessor, multi-core processor, integrated-circuit, ASIC, FPGA, programmable logic device, or any appropriate combination of these components. Non-transitory controller-readable storage medium 113 stores controller readable instructions thereon, which when executed by the controller 112 cause the controller to execute any number of functions, including directing signals between different components of wearable device 100, receiving user input, managing user interfaces, generating display content to be presented to a user, receiving and managing data from any sensors carried by wearable device 100, receiving and processing external data and messages, and/or any other functions as appropriate for a given application. The non-transitory controller-readable storage medium 113 is any suitable component which stores instructions, logic, programs, or data including but not limited to non-volatile or volatile memory, read only memory (ROM), random access memory (RAM), FLASH memory, registers, magnetic hard disk, optical disk, or any combination of these components.

Communications module 115 includes at least one transmitter, at least one receiver, and/or at least one transceiver. In some embodiments, communications module 115 includes an interface for wired communication or an interface for wireless communication. Communications module 115 includes long-range wireless communication hardware, such as hardware which enables 2G, 3G, 4G, 5G, LTE, or other forms of wireless communication. In some embodiments, communications module 115 includes short-range wireless communication hardware, such as hardware which enables Bluetooth®, ZigBee®, WiFi®, or other forms of wireless communication. In this way, communications module 115 enables wearable device 100 to communicate with peripheral devices, network infrastructure such as cellular communications towers, and remote servers.

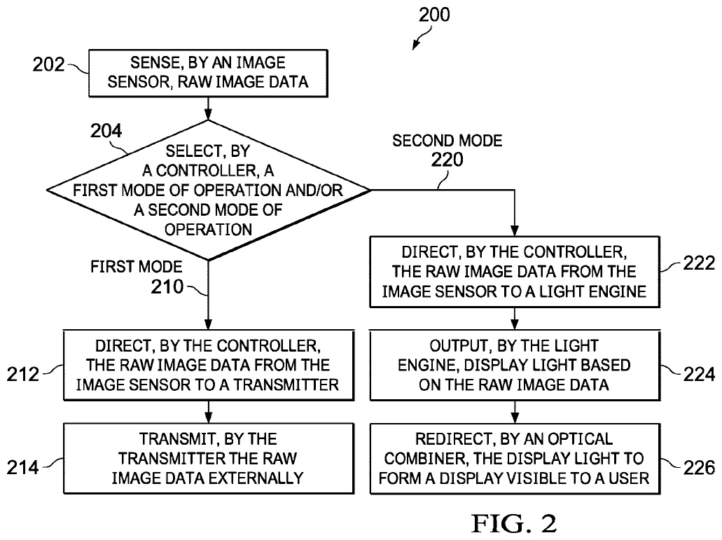

FIG. 2 is a flowchart diagram which illustrates a method 200 of selecting between directing raw image data to a transmitter and directing raw image data to a light engine for display in accordance with some embodiments. In some embodiments, method 200 is performed on a wearable device, such as wearable device 100 in FIG. 1. At block 202, an image sensor of the wearable device senses image data. At block 204, a controller of the wearable device selects a mode of operation, which can include a first mode of operation 210 and/or a second mode of operation 220. As discussed in more detail later, the first mode of operation 210 and the second mode of operation 220 are not necessarily exclusive: in some implementations the first mode of operation 210 and the second mode of operation 220 are carried out concurrently.

In the first mode of operation 210, the acts in blocks 212 and 214 are performed. At block 212, the controller directs raw image data from the image sensor to a transmitter of the wearable device. At block 214, the transmitter transmits the raw image data external to the wearable device. In summary, first mode of operation 210 is a path for raw image data to be transmitted external to the wearable device.

In the second mode of operation 220, the acts in blocks 222, 224, and 226 are performed. At block 222, the controller directs the raw image data from the image sensor to a light engine of the wearable device. At block 224, the light engine outputs display light based on the image data. At block 226, an optical combiner of the wearable device redirects the display light to form a display visible to a user of the wearable device. In summary, second mode of operation 220 can be a path for image data from the image sensor to be used to drive a display including the light engine.

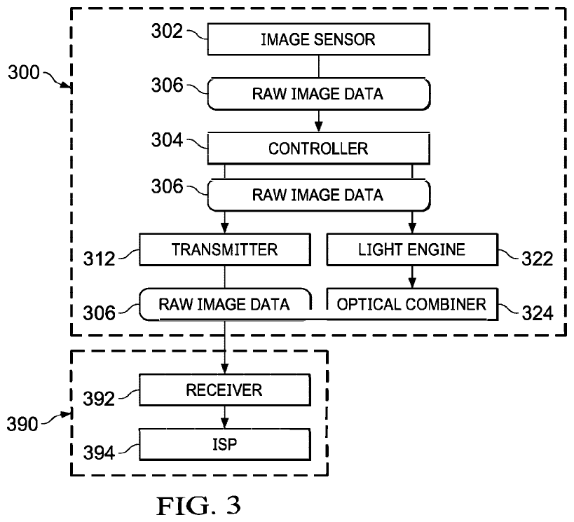

By directing the raw image data from the image sensor to either the transmitter or the light engine, the controller obviates the need to include an “ISP” or similar processor in the wearable device in the context of method 200. As an example, raw image data sensed by the image sensor can be directed to the transmitter and transmitted in the first mode of operation 210. ISP functionality can be performed by a remote device or server, as described later with reference to FIG. 3. Advantageously, this will save power on the wearable device, since intensive ISP operations can be avoided. Further, ISP hardware can be left out of the wearable device, thereby saving space and weight. Further still, ISPs can be designed to enhance image data, such as by interpolating between pixels to increase resolution. However, such enhancements will increase the size of the image data, and thus will increase the power and time used when transmitting the image data. Instead, transmitting raw image data sensed by the image sensor as in the present invention can, keep transmission power and time costs low.

Similarly, raw image data sensed by the image sensor can be directed to the light engine and used to directly drive the light engine. For example, the image data from the image sensor may include a plurality of color channels, and each color channel may be used to directly drive a corresponding color channel of the light engine.

FIG. 3 is a schematic diagram of an exemplary system for selecting between directing raw image data to a transmitter and directing raw image data to a light engine for display in accordance with some embodiments. The system of FIG. 3 includes a wearable device 300 and a remote device 390. In some embodiments, wearable device 300 is similar to wearable device 100 in FIG. 1. Remote device 390 is a peripheral device such as peripheral device 190 in FIG. 1 or, in some embodiments, is a remote server or similar.

Wearable device 300 includes an image sensor 302, which senses raw image data 306 as in act 202 of method 200. Wearable device 300 also includes a controller 304, which selects a first mode of operation and/or a second mode of operation as in act 204 of method 200. Wearable device 300 also includes a transmitter 312. When controller 304 selects the first mode of operation, controller 304 directs raw image data 306 from image sensor 302 to transmitter 312 as in act 212 of method 200. Transmitter 312 transmits the received raw image data 306 external to wearable device 300, as in act 214 of method 200.

The raw image data 306 transmitted by transmitter 312 is received by a receiver 392 of remote device 390. The receiver 392 provides the received image data 306 to an ISP 394 on remote device 390. ISP 394 performs any desired operations on the received raw image data 306, such as demosaicing (interpolating color values from a sensor array), autofocus, autoexposure, auto color balancing, noise reduction, filtering, shading, distortion, and other image processing functions. In some embodiments, ISP 394 is dedicated ISP hardware on the remote device 390. Alternatively, ISP 394 is a set of logical operations performed by a general-purpose processor. As an example, if remote device 390 is a smartphone, raw image data 306 received from wearable device 300 can be processed by a general-purpose processor of the smartphone. As another example, if remote device 390 is a smartphone, raw image data 306 received from wearable device 300 can be processed by ISP hardware on the smartphone, such as ISP hardware associated with an image sensor built into the smartphone. As another example, if remote device 390 is a purpose-built processing pack, remote device 390 may include purposed-built ISP hardware for processing image data received from wearable device 300. As another example, if remote device 390 is a remote server such as a cloud, server, ISP functions could be performed by a virtual ISP which runs on at least one processor of the remote server.

In the system illustrated in FIG. 3, wearable device 300 includes a light engine 322 and an optical combiner 324. Light engine 322 includes at least one light source which outputs display light (such as light engine 111 illustrated in FIG. 1). Optical combiner 324 receives the display light from the light engine 322 and redirects the display light towards an eye of a user. An exemplary display architecture is described with reference to FIG. 8 below.

When controller 304 selects the second mode of operation, controller 304 directs raw image data 306 from image sensor 302 to light engine 322, as in act 222 of method 200. Light engine 322 outputs display light based on the received raw image data 306, as in act 224 of method 200. Optical combiner 324 of wearable device 300 receives the display light and redirects the display light towards an eye of a user to form a visible display, as in act 226 of method 200.

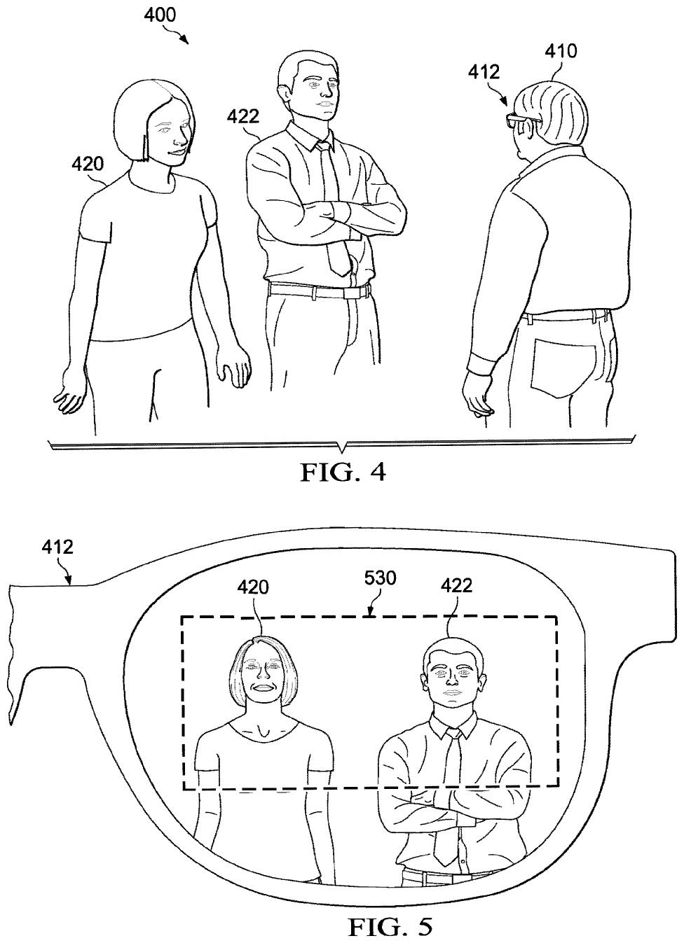

FIGS. 4 and 5 illustrate an exemplary use case for the system of FIG. 3 and method 200 of FIG. 2. FIG. 4 is a perspective view of a scene 400 including a user 410, where user 410 is using a wearable device 412. User 410 may be using a camera capture feature of wearable device 412, intended to capture image data for storage and subsequent viewing. User 410 is facing two people: subject 420 and subject 422. FIG. 5 is a view of a “preview” 530 presented to user 410 by wearable device 412. “Preview” 530 can be displayed by a display of wearable device 412, to show the user 410 what will be captured by an, image sensor of wearable device 412. An alternative term for “preview” in this context is “viewfinder”.

In a device where an image sensor is paired or integrated with an onboard ISP, image data from the image sensor would first be run through the ISP and optimized, and a display of the device could receive this optimized image data and display the optimized image data in, a preview. However, this is inefficient for several reasons. First, the quality of image data, likely does not need to be optimized for the purpose of a “preview”, since the purpose of the preview is to provide an approximation of what image data sensed by the image sensor will look like. In particular, a preview is helpful for informing a user of the composition, of image data being sensed; i.e., the relative positioning and size of features represented in the image data, and the boundaries of image data being sensed. High quality image and color data may not be necessary for such purposes. Further, if the display of the device is only capable of low-quality display output, it is possible that any optimizations achieved by the ISP will not be discernible in the preview anyway. Further, in some cases the “preview” image data is not stored; rather, the user views the preview until selecting to capture image data, at which point the image sensor will sense image data to be stored. The image data which is stored is the image data sensed after the user selects to capture image data. Consequently, the power consumed by performing ISP operations for the preview can largely be a waste.

In the present invention, on the other hand, when the controller 304 selects the second mode of operation 220, the controller 304 directs raw image data sensed by the image sensor directly (or relatively directly, without substantial ISP processing) to a display which outputs a preview based on the raw image data. Since the intent is to display just a preview, even without substantial ISP processing, the displayed preview can be of sufficient quality to enable the user 410 to understand approximately what will be captured. Thus, a large amount of power and time can be saved on ISP processing. Further, when the user 410 selects to capture the image data, the controller 304 selects the first mode of operation 210, and directs raw image data sensed by the image sensor to the transmitter 312 for external transmission, where ISP processing is performed external to the wearable device to provide high-quality stored image data. Thus, power and time can be saved on the wearable device even when the image data is to be stored.

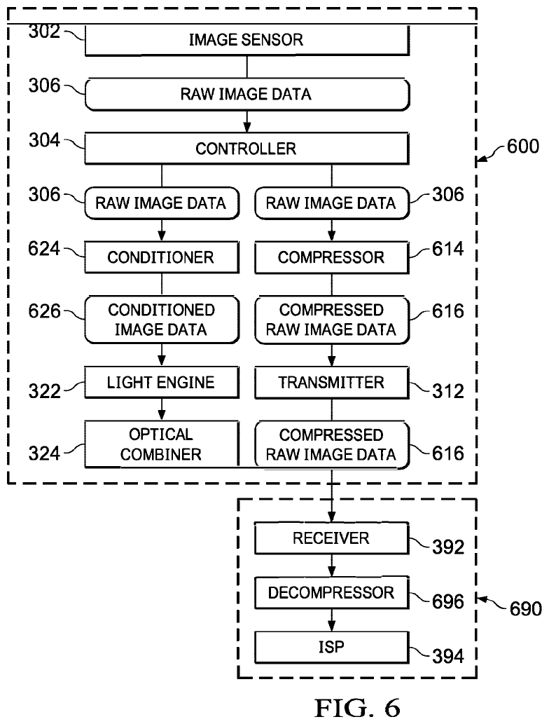

FIG. 6 is a schematic diagram of a system for performing method 200 as described with reference to FIG. 4. The system of FIG. 6 includes, a wearable device 600 and a remote device 690. The system illustrated in FIG. 6 is similar to the system illustrated in FIG. 5. For example, wearable device 600 and remote device 690 in FIG. 6 are similar to wearable device 300 and remote device 390, respectively, in FIG. 3. The description of elements in FIG. 3 is applicable to similarly numbered elements in FIG. 6.

Wearable device 600 differs from wearable device 300 in that wearable device 600 includes a compressor 614. When controller 304 selects the first mode of operation 210, directing raw image data 306 from image sensor 302 to transmitter 312 includes controller 304 directing the raw image data 306 from image sensor 302 to compressor 614. Compressor 614 compresses the received raw image data 306 as compressed raw image data 616 and provides the compressed raw image data 616 to the transmitter 312. Transmitter 312 transmitting the raw image data comprises transmitter 312 transmitting the compressed raw image data 616 external to wearable device 600.

Remote device 690 differs from remote device 390 in that remote device 690 includes a decompressor 696. Receiver 392 receives compressed raw image data transmitted by transmitter 312 and provides the compressed raw image data to decompressor 696. Decompressor 696 decompresses the compressed raw image data and provides decompressed raw image data to ISP 394 for processing. Decompressor 696 includes dedicated decompression hardware, or in some embodiments includes logical decompression instructions performed by a processor.

By compressing raw image data 306 on wearable device 600 prior to transmitting the raw image data 306, the size of data to be transmitted is reduced. This in turn reduces the power consumed by transmission, as well as the time of transmission. Further, controller 304 directs raw image data 306 from image sensor 302 to compressor 614, without extensive ISP operations thereon, which can further result in reduced, data size. In particular, ISP operations often increase the size of image data, by interpolating between pixels and/or by performing nearest-neighbor pixel approximations to increase the resolution of the image data. However, such resolution increases result in corresponding increases to the size of image data. Thus, compressing the raw image data is more efficient. Further still, raw image data compression can be performed on a per-color channel basis, where each color channel is compressed separately. This can also reduce the size of the compressed image data by exploiting a greater proportion of repeated information in the image data.

Wearable device 600 further differs from wearable device 300 in that wearable device 600 includes an image data conditioner (“conditioner”) 624. As illustrated in FIG. 6, when, controller 304 selects the second mode of operation 220, directing raw image data 306 from image sensor 302 to light engine 322 includes controller 304 directing the raw image data 306 from image sensor 302 to conditioner 624. Conditioner 624 performs conditioning on the raw image data to produce conditioned image data 626 and provides the conditioned image data 626 to light engine 322 to drive the light engine 322. “Conditioning” the image data refers to performing some mild or moderate optimization of image data to be compatible with light engine 322, without being as intensive, as full ISP processing. Several examples of image data conditioning are detailed below.

Although FIG. 6 illustrates wearable device 600 as including both a compressor 614 and a conditioner 624, these elements are not necessarily required together. For example, a wearable device could include a compressor but no conditioner, and likewise a wearable device could include, a conditioner by not compressor.

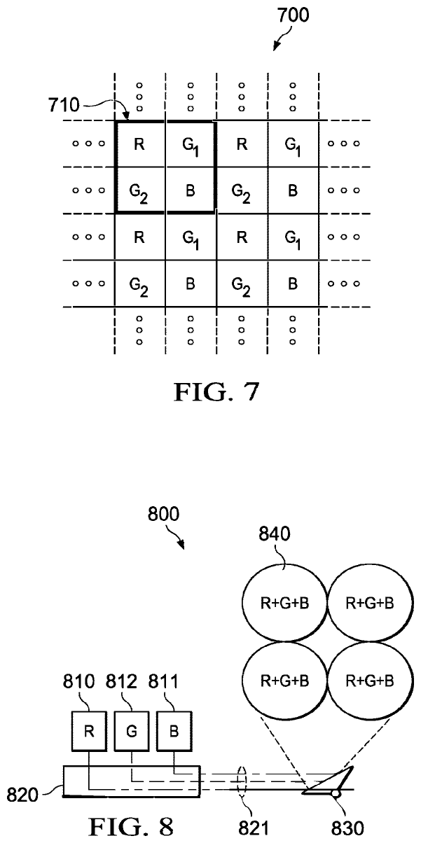

Image sensors can comprise an array of color specific sensing cells or pixels. That is, a given sensing cell of an image sensor may only sense photons having a wavelength within a certain waveband, and other sensing cells may only sense photons having a wavelength within a different waveband. This concept is illustrated in FIG. 7, which is a schematic view of a portion of an exemplary image sensor.

FIG. 7 illustrates a portion of an image sensor 700. Image sensor 700 includes a plurality of cells, where each cell is sensitive to incident light having a wavelength within a specific waveband. Although FIG. 7 only shows sixteen cells of image sensor 700, in practice the image sensors described herein may include many more cells. In such cases, the pattern of cells shown in FIG. 7 can be repeated across an entire area of an image sensor.

In the example shown in FIG. 7, each cell labelled “R” can sense light having a wavelength in a first waveband. Each cell labelled “B” can sense light having a wavelength in a second waveband. Each cell labelled “G₁” can sense light having a wavelength in a third waveband. Each cell labelled “G₂” can sense light having a wavelength in a fourth waveband. The different wavebands of light sensed by the image sensor can correspond to respective color channels. In particular, image data sensed by the cells labelled “R” represents a first color channel; image data sensed by the cells labelled “B” represents a second color channel; image data sensed by the cells labelled “G₁” represents a third color channel; image data sensed by the cells labelled “G₂” represents a fourth color channel.

In the example of FIG. 7, the first waveband includes wavelengths corresponding to red light, the second waveband includes wavelengths corresponding to blue light, and the third waveband and the fourth waveband include wavelengths corresponding to green light. This example corresponds to a Bayer arrangement. In some embodiments, each of the first waveband, second waveband, third waveband, and fourth waveband is narrow, such that only a small range of wavelengths can be sensed by each sensor. Further, the third waveband and the fourth waveband may be the same, such that cells labelled “G₁” and “G₂” sense the same wavelengths of light. This can improve overall sensitivity to light in the third and fourth wavebands. Alternatively, the third waveband and the fourth waveband may be different, such that cells labelled “G₁” and “G₂” sense different wavelengths of light. This can improve color accuracy and range of the image sensor. Although the example discussed above describes sensors for red light, green light, and blue light, alternative ranges of color could be detected by any of the sensors discussed herein.

Image data sensed by an image sensor such as image sensor 700 in FIG. 7 will include four color channels. In implementations where an image sensor can sense a plurality of color channels and a light engine can output an equal number of color channels, the image sensor and the light engine could be designed such that each color channel of the light engine closely approximates a corresponding color channel in the image sensor. That is, each wavelength of display light output by a light engine could closely approximate each wavelength of light which is sensed by the image sensor. In this way, a given light source in the light engine can be driven directly by image data from a corresponding color channel in the image sensor.

However, a display of a wearable device may not be driven according to four color channels. For example, many display architectures are driven according to three color channels. FIG. 8 is a schematic view of an example scanning laser projector (“SLP”) based light engine 800 for a display which is driven according to three color channels.

Light engine 800 includes three laser diodes 810, 811, and 812. First laser diode 810 outputs first display light having a wavelength in a first waveband. Second laser diode 811 outputs second display light having a wavelength in a second waveband different from the first waveband. Third laser diode 812 outputs third display light having a wavelength in a third waveband different from the first waveband and the second waveband.

The first, second, and third display light impinge on a beam combiner 820, which combines the first, second, and third display light into an aggregate beam 821. Beam combiner 820 is shown in FIG. 8 as comprising a plurality of wavelength specific reflectors (e.g. dichroic reflectors). In practice, any appropriate beam combiner could be used, such as a photonic integrated circuit, for example. Aggregate beam 821 impinges on a spatial modulator 830, which includes at least one movable mirror in some embodiments. For example, in some embodiments, spatial modulator 830 includes a single MEMS device rotatable along two axes. In other embodiments, spatial modulator 830 includes two MEMS devices, each rotatable along a different axis. Spatial modulator 830 redirects aggregate beam 821 across a scanning area. By controlling emission timing of each of the light sources and motion of spatial modulator 830, aggregate beam 821 is controlled to scan across a display area where each instance of aggregate beam 821 produces a multi-colored spot 840, approximately corresponding to a pixel. The output from spatial modulator 830 is scanned onto an optical combiner, which in turn redirects the scanned light towards an eye of a user to form a display.

The light engine 800 in FIG. 8 illustrates an exemplary light engine which includes only three light sources. However, any appropriate number of light sources could be included in the displays described herein. For example, in some embodiments, an SLP-based light engine includes four laser diodes. As another example, a microdisplay-based light engine includes an array of pixels grouped into clusters of four pixels, each pixel in a given cluster outputting display light having a wavelength in a specific waveband.

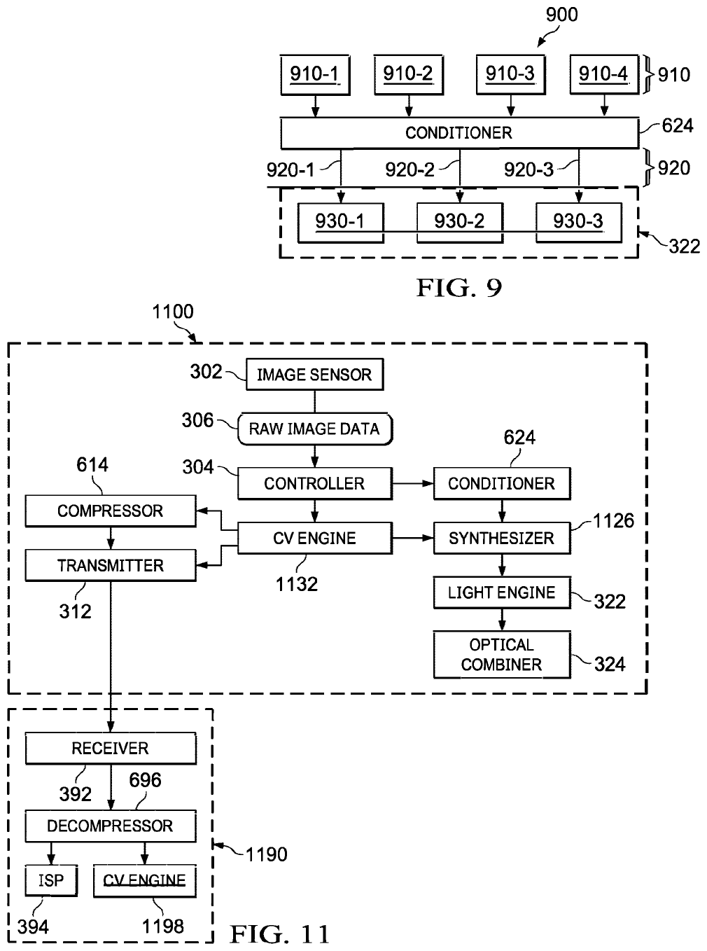

However, in cases where the number of color channels in the sensed image data is different from the number of color channels in the light engine, this difference should be compensated for. Exemplary techniques for accomplishing such are discussed with reference to FIG. 9 discussed below.

FIG. 9 is a block diagram of an image data pipeline 900, which includes a conditioner 624 which receives image data 910 from an image sensor, conditions the image data, and outputs conditioned image data 920, The conditioned image data 920 is provided to a light engine 322, which outputs display light based on the conditioned image data 920.

In the example illustrated in FIG. 9, image data 910 includes four color channels 910-1, 910-2, 910-3, and 910-4, each representing a respective color. As discussed above, in some cases each color channel represents a corresponding color. For example, in some embodiments, image data 910-1 represents a red color channel (“R”) image data 910-2 represents a blue color channel (“B”), image data 910-3 represents a first green color channel (“G₁”), and image data 910-4 represents a second green color channel (“G₂”). In some cases, different color channels in the image data are redundant (e.g., G₁ could represent the same waveband as G₂). In some cases, each color channel represents a different color waveband (e.g. G₁ represents a different waveband from G₂).

In the example of FIG. 9, image data 910 includes four color channels, whereas light engine 322 outputs three color channels of display light. Conditioner 624 compensates for this difference in several different ways discussed below.

In one example, conditioner 624 drops a channel of the image data 910. For example, conditioner 624 directs color channel 910-1 to light source 930-1 (along the path illustrated as conditioned color channel 920-1), and light engine 322 drives light source 930-1 according to color channel 910-1. Conditioner 624 directs color channel 910-2 to light source 930-2 (along the path illustrated as conditioned color channel 920-2), and light engine 322 drives light source 930-2 according to color channel 910-2. Conditioner 624 directs color channel 910-3 to light source 930-3 (along the path illustrated as conditioned color channel 920-3), and light engine 322 drives light source 930-3 according to color channel 910-3. Conditioner 624 drops color channel 910-4; that is, color channel 910-4 is not directed to any light source, and light engine 322 does not drive any light source according to color channel 910-4. Such an implementation is particularly effective for cases where certain color channels represent the same color waveband. As an example, if G₁ represents the same color waveband as G₂, one of color channel G₁ or color channel G₂ could be dropped. In cases where each color channel represents a different color waveband, dropping a color channel may result in loss of some accuracy in the display of the image data, but this may be acceptable for certain purposes, such as an image preview. In this example, even though each of the paths labelled as 920-1, 920-2, and 920-3 are each referred to as “conditioned color channel”, the image data along each path need not be specifically or individually conditioned; rather, the image data as a whole can be considered as “conditioned” in that a color channel has been dropped. However, it is also possible for each color channel to be “conditioned” as described below.

In another example, conditioner 624 combines multiple color channels of image data 910 into a single color channel of conditioned image data 920, For example, in some embodiments, color channel 910-3 and color channel 910-4 of the image data are combined by conditioner 624 as conditioned color channel 920-3, which is directed to light source 930-3. This combination of color channels includes, for example, summing the values of the color channels or averaging the values of the color channels. In this way, even though the number of color channels output by light engine 322 is reduced, the displayed colors will more closely approximate the color channels represented in the image data 910.

In some embodiments, conditioner 624 performs functions beyond modifying the number of color channels in the image data 910 to match the number of color channels in the light engine 322. As one example, in some embodiments, conditioner 624 performs color balancing on the image data. For example, conditioner 624 applies a respective scaling factor to each of the color channels of image data 910, to adjust the relative brightness of each of the color channels output as conditioned image data 920. As an example, in a case where image data 910 includes color channels 910-3 and 910-4 which represent the same color waveband, color channels 910-3 and 910-4 may have relatively low brightness compared to color channels 910-1 and 910-2, to compensate for the redundancy. However, if color channel 910-4 is dropped in conditioned image data 920, conditioned color channel 920-3 may have an undesirably low brightness compared to conditioned color channels 920-1 and 920-2, since part of the 910-3/910-4 color waveband data was dropped.

Consequently, conditioner 624 applies a scaling factor to color channel 910-3, to produce conditioned color channel 920-3 in the conditioned image data 920, which is adjusted to have brightness which accurately correlates to color channels 920-1 and 920-2.

Although the above example illustrates applying a scaling factor to increase brightness of one color channel, a different scaling factor could be applied to each of the color channels to adjust the relative brightness and color balance. Such scaling factors could increase or decrease relative brightness of a given color channel. Further, such scaling factors can be applied regardless of the number of color channels in image data 910 and number of light sources in light engine 322.

A distinction between conditioner 624 and an ISP is that conditioner 624 performs relatively light operations compared to an ISP. In the examples discussed above, conditioner 624 performs combining of color channels (e.g. addition), and scaling of color channels (e.g. multiplication), which can be performed with minimal processing resources and power. An ISP, on the other hand, performs processing-intensive operations like interpolation, noise reduction, filtering, shading, distortion, and other intensive image processing functions.

A further distinction between conditioner 624 and an ISP is that conditioner 624 is selectively operable. That is, conditioner 624 may be operated in modes where image data from an image sensor is to be displayed by a wearable device, but is not operated in, other modes. Typically, an ISP is closely coupled to or integrated with an image sensor to promptly perform ISP functions on image data after sensing, regardless of how the image data is to be used.

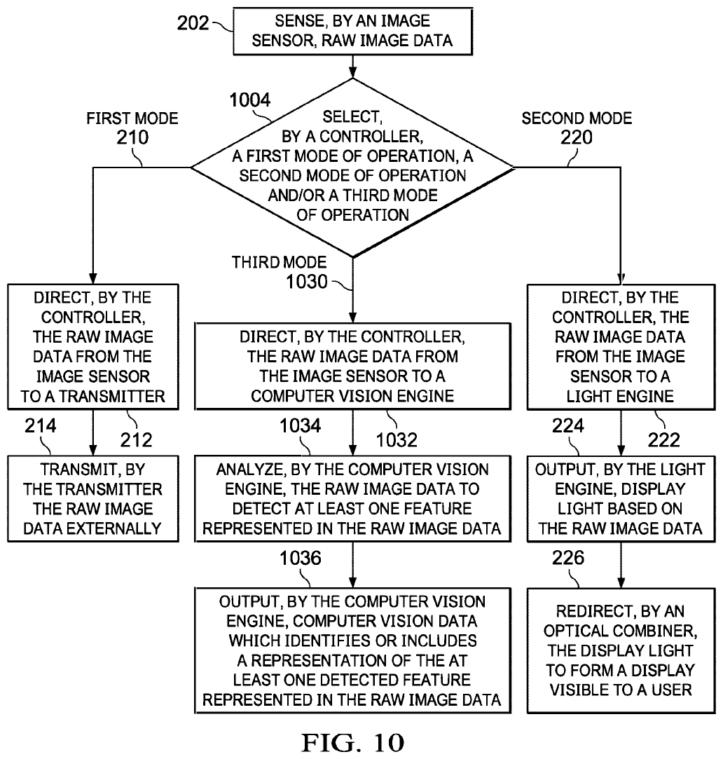

FIG. 10 is a flow chart illustrating a method 1000 of selecting between transmitting raw image data externally, directing raw image data for display, and directing raw image data to a computer vision engine in, accordance with some embodiments. In some embodiments, method 1000 is performed on a wearable device, such as wearable device 100 in FIG. 1. Method 1000 in FIG. 10 is similar in at least some respects to method 200 in FIG. 2. Description of elements of method 200 can be applicable to similarly numbered elements of method 1000.

Method 1000 differs from method 200 in that at box 1004, instead of selecting a first mode of operation and/or a second mode of operation, a controller of the wearable device selects a mode of operation from a first mode of operation 210, a second mode of operation 220, and/or a third mode of operation 1030. First mode 210 and, second mode 220 are similar to the blocks described with reference to FIG. 2. As discussed in more detail later, the first mode of operation 210, the second mode of operation 220, and the third mode of operation 1030 are not necessarily exclusive: in some implementations the first mode of operation 210, the second mode of operation 220, and/or the third mode of operation 1030 are, carried out concurrently.

In the third mode of operation 1030, the acts in boxes 1032, 1034, and 1036 are performed. At box 1032, the controller of the wearable device directs raw image data from the image sensor 302 to a computer vision engine (“CV Engine”) of the wearable device. At box 1034, the CV engine analyzes the raw image data to detect at least one feature represented in the raw image data. At box 1036, the computer vision engine outputs computer vision data which identifies or includes a representation of the at least one detected feature represented in the raw image data.

As discussed with reference to FIG. 2, an “ISP” or similar is avoided in the wearable device in the context of method 1000. As an example, raw image data sensed by the image sensor is directed to the CV engine in the third mode of operation 1030. ISP functionality is performed by a remote device or server, thus saving power on the wearable device, since intensive ISP operations can be avoided. Further, ISP hardware can be left out of the wearable device, thereby saving space and weight.

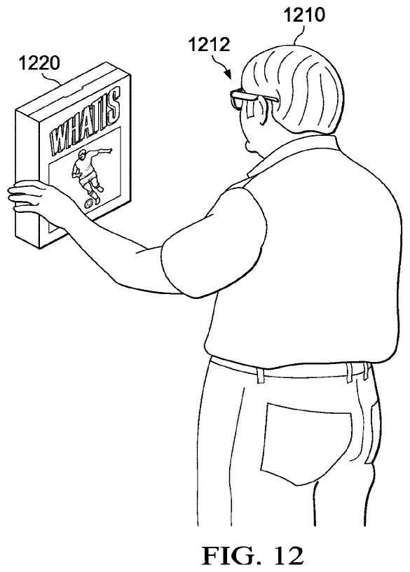

FIG. 11 is a block diagram of a system for performing method 1000 as described with reference to FIG. 10. The system of FIG. 11 includes a wearable device 1100, similar to wearable device 100 in FIG. 1 wearable device 300 in FIG. 3, or wearable device 600 in FIG. 6, and a remote device 1190, similar to peripheral device 190 in FIG. 1, remote device 390 in FIG. 3 or remote device 690 in FIG. 6. Descriptions of elements with reference to at least FIGS. 3, 6, 8, and 9 apply to similarly numbered elements in FIG. 11.

Wearable device 1100 in FIG. 11 differs from wearable device 600 in FIG. 6 in that wearable device 1100 includes a computer vision (“CV”) engine 1132. In some embodiments, wearable device 1100 further includes a synthesizer 1126. When controller 304 selects the third mode of operation 1030 as in FIG. 10, controller 304 directs raw image data from image sensor 302 to CV engine 1132. CV engine 1132 analyzes the raw image data to identify at least one feature represented in the raw image data, as in box 1034 of method 1000. CV engine 1132 then outputs computer vision data 1134 which identifies or includes a representation of the at least one feature detected in the raw image data. In some embodiments, CV engine 1132 includes dedicated hardware, such as a convolution inference engine (CIE). In some implementations, CV engine 1132 includes a logical set of machine intelligence instructions stored on a non-transitory processor readable storage medium, executed by a processor.

In some embodiments, synthesizer 1126 receives computer vision data 1134 from CV engine 1132 and modifies display light output by light engine 322 based on the computer vision data. Such modification includes color and/or brightness adjustment of regions of image data to be output, as well as replacement of some regions of image data to be output. Modification of image data to be output by light engine 322 can be helpful for providing an accurate “preview” to a user when the user is capturing image data which is to be modified to include virtual content or augmented reality (“AR”) content. For example, in some embodiments synthesizer 1126 modifies image data from image sensor 302 to output synthesized image data 1128 including virtual content (AR content). Further, if the AR content is intended to be perceived as a solid object, regions of image data which correspond to where the AR content is located are replaced by synthesized, image data 1128 representing the AR content. In this way, the AR content can appear to occlude regions of the scene which are behind the AR content.

In some embodiments, a “preview” is displayed by a display of wearable device 1212 to show the user 1210 what will be captured by an image sensor of wearable device 1212. Other exemplary virtual or AR content can be included in the preview. For example, in some embodiments, color filters are applied to the image data, which includes producing synthesized image data with a modified color balance compared to the raw image data from the image sensor. Such filters modify the raw image data from the image sensor, without completely replacing regions of the raw image data. As another example, translucent or opaque decorative frames are added in the synthesized image data. As another example, modifications are implemented which stretch, compress, or reshape portions of the image data, such as reshaping the eyes, head, nose, or mouth of a subject in the synthesized image data 1128. Further, different virtual or AR elements could be added in combination. For example, any combination of virtual or AR elements like frames, color filters, and feature modification (e.g., antlers, noses, eyes, mouths, etc.) could be implemented.

Analyzing and modifying image data from image sensor 302 to output synthesized image data 1128 including high-quality virtual or AR content is processor intensive. Thus, it can be desirable to perform such high-quality analysis and modification on remote device 1190. However, to assist the user in effectively capturing image data, such as capturing the right photograph composition, it can be desirable to provide the user with at least an approximation of what the virtual or AR content will look like via a preview. To this end, CV engine 1132 and synthesizer 1126 perform light, minimal, or relatively low-quality analysis and generating of synthesized image data in some embodiments, to provide an approximate preview to the user, without excessively burdening the wearable device with intensive and costly image processing operations. Thus, in the example of FIG. 11, controller 304 directs raw image data from image sensor 302 to transmitter 312 in first mode of operation 210, for transmission external to wearable device 1100. In some embodiments, compressor 614 compresses the computer vision data is compressed prior to transmission. A receiver 392 of remote device 1190 receives the computer vision data transmitted from wearable device 1100, and the decompressor 696 decompresses the received computer vision data, if necessary. Computer vision engine 1198 on remote device 1190 then performs high-quality virtual or AR synthesis to produce high-quality photographs for storage and subsequent viewing.

To illustrate, FIG. 12 depicts a perspective view of an exemplary scene in which a user 1210 is wearing a wearable device 1212 in accordance with the present specification. User 1210 is looking at a subject 1220, which is a box of cereal in the illustrated example. An image sensor 302 of wearable device 1212 senses raw image data including a representation of subject 1220, and a controller 304 of the wearable device 1212 directs the image data to a CV engine 1132. CV engine 1132 analyzes the image data, and identifies at least one feature of subject 1220. The depth of analysis performed by CV engine 1132 can be designed based on optimizing power efficiency, analysis speed, and analysis quality. Several examples are discussed below.

In one example, CV engine 1132 identifies boundaries of the representation of subject 1220 in the raw image data CV engine 1132 then outputs computer vision data which includes the identified boundaries. In some embodiments, the computer vision data includes some of the raw image data from the image sensor, limited to only a subset of raw image data that fits within the identified boundaries. That is, CV engine 1132 crops the raw image data to excise portions of the raw image data which do not contain the subject 1220 which the user 1210 is looking at. CV engine 1132 then provides the cropped raw image data to transmitter 312 for transmission external to the wearable device. In some embodiments, the compressor 614 compresses the cropped raw image data prior to transmission. In, some embodiments, the CV engine 1132 identifies the boundaries of subject 1220, but another element performs the cropping of the raw image data. For example, in some cases controller 304 operates in both the first mode 210 and the third mode 1030 concurrently, such that controller 304 directs image data from the image sensor 302 to both CV engine 1132 and compressor 614. CV engine 1132 analyzes the raw image data from image sensor 302, and provides computer vision data which identifies the boundaries of subject 1220 to compressor 614. In turn, compressor 614 crops portions of the raw image data from image sensor 302 based on the boundaries identified in the computer vision data, to provide compressed raw image data to transmitter 312. Transmitter 312 in turn transmits the compressed image data external to the wearable device.

In the above example, receiver 392 of remote device 690 receives the compressed/cropped raw image data and decompresses the received raw image data, A computer vision engine 1198 on remote device 1190 then performs further analysis to identify additional features of the product 1220. For example, in some embodiments the computer vision engine 1198 identifies the brand and flavor of product 1220, which enables searching for pricing information for product 1220 at other retailers, which is then communicated back to user 1210 via wearable device 1212. In this way, computer vision performed on the wearable device 1100 is reduced, with more intensive computer vision analysis performed by the remote device 1190. Such an implementation saves power and time at the wearable device, and also enables a smaller computer vision engine on the wearable device.

In another example, CV engine 1132 identifies specific features of subject 1220 in the image data. For example, CV engine 1132 produces a number of tags which describe product 1220, such as “cereal”, “food”, or “box” tags which identify the brand, flavor, or manufacturer of the cereal, or any other appropriate tag which describes product 1220. CV engine 1132 then outputs computer vision data which includes the identified tags. CV engine 1132 provides this computer vision data to transmitter 312 for transmission external to the wearable device 1212. In some embodiments, the compressor 614 compresses the computer vision data prior to transmission. Transmitting tags, as opposed to image data, reduces the amount of data to be transmitted, reducing power and time use. Remote device 1190 receives the transmitted tags, and performs operations based on the tags, such as searching for subject 1220 in a shopping or price comparison database.

In some embodiments, the above examples are performed in tandem, where computer vision data including tags is transmitted as well as raw image data including subject 1220. Which of tags and/or raw image data is transmitted depends on the specific computer vision application which is being utilized. For example, if a user wishes to search an online database for prices of a specific product, as in FIG. 12, tags including the brand and product name may be sufficient. On the other hand, if the user wishes to search an online database to identify a person, or if CV engine 1132 determines that the raw image data is to be used, for a facial recognition application or interaction assistant application, the controller 304 selectively chooses to operate in the first mode of operation 210, second mode of operation 220, or third mode of operation 1030 at least partially based on the computer vision.

In some implementations, computer vision data is produced and utilized on wearable device 1100, with no computer vision data being transmitted externally to wearable device 1100. As an example, in some embodiments, if wearable device 1100 runs in a mode which detects when a user is interacting with another human, wearable device 1100 disables or limits notifications until the interaction is over.

In several implementations discussed herein, a controller of a wearable device selects at least one mode of operation, such as first mode of operation 210, second mode of operation 220, and third mode of operation 1030. The selection can be based on a number of factors, for example user input or environmental context parameters of the wearable device. Such user input includes a user interacting with an interface, such as buttons, a trackpad, or sensors on the wearable device, or interfaces on a remote control device such as a ring, wristband, or pad in communication with the wearable device. Environmental context parameters include data which indicates an context of the wearable device, and could be provided by sensors such as any of an accelerometer, an IMU, a GPS, a microphone, an image sensor, or any other appropriate sensor. Environmental context parameters also include data retrieved from at least one non-transitory processer readable storage medium on the wearable device or on a remote device, and could include for example a time of day, a date, calendar information of a user, or any other appropriate data.

In some embodiments, a user uses an input device to select a camera capture mode of the wearable device (e.g., capturing a photograph or video for storage). Based on this selection, the controller selects a second mode of operation 220 to present a preview to the user. In response to the user providing an input to capture image data, the controller selects first mode of operation 210 to transmit raw image data external to the wearable device. The controller concurrently operates in the first mode 210 and the second mode 220, to provide a preview while transmitting data, such as when a user is capturing a video.

In some embodiments, a user provides an input to use computer vision functionality of a wearable device, and a controller of the wearable device selects a third mode of operation 1030, where the controller directs raw image data from an image sensor to a computer vision engine. In some implementations, the computer vision engine analyzes the raw image data to produce computer vision data. Such computer vision data is provided to the controller, which in turn selects a mode of operation based on the computer vision data. As an example, if the computer vision engine determines that the user is looking at a product on a shelf, the controller chooses a first mode of operation 210, where raw image data from the image sensor is transmitted external to the wearable device to a remote device. Subsequently, a computer vision engine of the remote device analyzes the raw image data to identify the product and provide purchase options or price comparison information. As another example, if the computer vision engine, of the wearable device determines that the user is interacting with another human, the computer vision data (or instructions) are provided to the controller or application processor of the wearable device, which restricts or blocks notifications until the interaction is over. In some embodiments, the controller of a wearable device selects a third mode of operation 1030 by default, so that the computer vision engine of the wearable device provides data which determines subsequent operating modes of the wearable device.

Note that not all of the activities or elements described above in the general description are required, that, a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems, have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A wearable heads-up display (“WHUD”) comprising:
an image sensor to sense and output raw image data;
a transmitter to transmit data external to the WHUD; and
a controller communicatively coupled to the image sensor and the transmitter, wherein the controller is configured to direct the raw image data from the image sensor to the transmitter for transmission to an image signal processor external to the WHUD.

2. The WHUD of claim 1, further comprising:
a light engine to output display light; and
an optical combiner to receive the display light and redirect the display light to form a display visible to a user of the WHUD;
wherein the controller is further configured to operate in a first mode and a second mode, wherein:
when the controller is operated in the first mode, the controller is to direct the raw image data from the image sensor to the transmitter, and the transmitter is to transmit the raw image data external to the WHUD; and
when the controller is operated in the second mode, the controller is to direct the raw image data from the image sensor to the light engine, and the light engine is to output the display light based on the image data.

3. The WHUD of claim 1, wherein the raw image data comprises a Bayer pattern image.

4. The WHUD of claim 2, further comprising an image data conditioner to condition the raw image data wherein:
the image data from the image sensor includes a plurality of color channels, wherein each color channel represents a color different from the colors of the other channels;
the light engine includes at least a plurality of light sources, each light source driven according to a corresponding one of the plurality of color channels to output display light having a wavelength in a waveband different from the wavebands of the other light sources; and
wherein the conditioner is to adjust a color channel of the plurality of color channels and provide conditioned image data to the light engine when the controller is operated in the second mode.

5. The WHUD of claim 4, wherein the conditioner is to adjust the color channel by summing or averaging the values of two of the color channels and provide the conditioned image data to the light engine when the controller is operated in the second mode.

6. The WHUD of claim 2, further comprising a computer vision engine, the controller further selectively operable in a third mode, wherein when the controller is operated in the third mode, the controller is to direct the image data from the image sensor to the computer vision engine, the computer vision engine to analyze the image data to detect at least one feature represented in the image data and optionally to output computer vision data which identifies or includes a representation of the at least one detected feature represented in the image data.

7. The WHUD of claim 6, further comprising a synthesizer, wherein when the controller is operated in the second mode, the controller is to direct the image data from the image sensor to the synthesizer, the synthesizer to synthesize the image data with virtual content and provide synthesized image data including the virtual content to the light engine, the light engine to output the display light based on the synthesized image data.

8. The WHUD of claim 2, further comprising a compressor, wherein when the controller is operated in the first mode, the controller is to direct the raw image data from the image sensor to the compressor, the compressor to compress the raw image data and provide compressed raw image data to the transmitter, the transmitter to transmit the compressed image data external to the WHUD.

9. A method, comprising:
sensing, by an image sensor of a wearable heads-up display (WHUD), raw image data; and
directing, by a controller of the WHUD, the raw image data from the image sensor to a transmitter for transmission of the raw image data external to the WHUD.

10. The method of claim 9, further comprising selecting, by the controller of the WHUD, to operate in at least one of a first mode and a second mode, wherein,
in the first mode, the controller is to direct the raw image data from the image sensor to the transmitter for transmission of the raw image data external to the WHUD; and
in the second mode, the controller is to direct the raw image data from the image sensor to a light engine of the WHUD for output of display light based on the raw image data.

11. The method of claim 10, wherein selecting comprises selecting to operate concurrently in the first mode and the second mode.

12. The method of claim 9, wherein the raw image data comprises a Bayer pattern image.

13. The method of claim 9, further comprising:
compressing the raw image data prior to directing the raw image data from the image sensor to a transmitter.

14. The method of claim 10, wherein:
sensing the raw image data comprises sensing raw image data comprising a plurality of color channels, each color channel representing a color different from the other colors; and
outputting, by the light engine, display light based on the raw image data comprises:
outputting, by at least a first light source of the light engine, first display light having a wavelength in a first waveband, based on a first color channel;
outputting, by at least a second light source of the light engine, second display light having a wavelength in a second waveband different from the first waveband, based on a second color channel; and
outputting, by at least a third light source of the light engine, third display light having a wavelength in a third waveband different from the first waveband and the second waveband, based on a third color channel.

15. The method of claim 10, wherein:
directing, by the controller, the raw image data from the image sensor to the light engine comprises:
directing, by the controller, the raw image data from the image sensor to an image data conditioner of the WHUD;
conditioning, by the image data conditioner, the raw image data to produce conditioned image data; and
providing, by the image data conditioner, the conditioned image data to the light engine for output of display light based on the conditioned image data.

16. The method of claim 10, wherein:
directing, by the controller, the raw image data to the light engine comprises:
directing, by the controller, the raw image data to a synthesizer of the WHUD;
synthesizing, by the synthesizer, the raw image data with virtual content as synthesized image data; and
providing, by the synthesizer, the synthesized image data to the light engine for output of display light based on the synthesized image data.

17. The method of claim 9, further comprising:
operating the controller in a third mode comprising:
directing, by the controller, the raw image data from the image sensor to a computer vision engine of the WHUD;
analyzing, by the computer vision engine, the raw image data from the image sensor to detect at least one feature represented in the image data; and
optionally outputting, by the computer vision engine, computer vision data which identifies or includes a representation of the at least one detected feature represented in the image data.

18. A wearable device, comprising:
an image sensor to sense raw image data;
a transmitter to transmit data external to the wearable device;
a computer vision engine; and
a controller communicatively coupled to each of the image sensor, the transmitter, and the computer vision engine, the controller selectively operable in at least a first mode and a second mode, wherein:
when the controller is operated in the first mode, the controller is to direct the raw image data from the image sensor to the transmitter, and the transmitter is to transmit the raw image data external to the wearable device; and
when the controller is operated in the second mode, the controller is to direct the raw image data from the image sensor to the computer vision engine, the computer vision engine to analyze the raw image data to detect at least one feature represented in the raw image data, and to output computer vision data which identifies or includes a representation of the at least one detected feature represented in the image data.

19. The wearable device of claim 18 wherein when the controller is operated in the second mode, the controller is to direct the raw image data directly from the image sensor to the computer vision engine.

20. The wearable device of claim 18 wherein when the controller is operated in the second mode, the computer vision data includes a portion of the raw image data from the image sensor, the portion of the raw image data comprising a subset of the raw image data from the image sensor.

21. The wearable device of claim 18 wherein when the controller is operated in the second mode, the computer vision data includes at least one tag which identifies at least one feature represented in the image data from the image sensor.
